(19) United States
(12) Patent Application Publication
(10) Pub. No.: US 2026/0216679 A1
(43) Pub. Date: Jul. 30, 2026

(54) METHODS OF OPERATING CHEMICAL PROCESSING VESSELS THAT INCLUDE SHROUDS

(71) Applicant: Dow Global Technologies LLC, Midland, MI (US)

(72) Inventors: Matthew T. Pretz, Lake Jackson, TX (US); John Peterson, Ashburn, VA (US); Donald F. Shaw, Forked River, NJ (US); Fermin Alejandro Sandoval, Pearland, TX (US); Albert Meza, Cypress, TX (US)

(73) Assignee: Dow Global Technologies LLC, Midland, MI (US)

(21) Appl. No.: 19/124,111

(22) PCT Filed: Oct. 27, 2023
(86) PCT No.: PCT/US2023/078019

§ 371 Date: Apr. 24, 2025

Related U.S. Application Data
(60) Provisional application No. 63/420,189, filed on Oct. 28, 2022.

(51) Int. Cl. B01J 8/18

(52) U.S. Cl. CPC B01J 8/1872; B01J 8/1845; B01J 2208/00495; B01J 2208/00796

(57) ABSTRACT

Chemical processing vessels and methods for their operation are disclosed herein. A chemical processing vessel may be operated by a method including contacting a chemical reactant with a fluidized particulate in the chemical processing vessel to form a chemical product, wherein the fluidized particulate and the chemical reactant moves in a generally upward direction through the chemical processing vessel. The chemical processing vessel may include an exterior vessel wall forming a continuous passage extending therethrough, wherein the exterior vessel wall has a wall temperature of less than 350° C. during operation. The exterior vessel wall may include a riser wall having a substantially continuous cross-sectional shape, a frustum wall positioned below the riser wall and having a variable cross-sectional shape extending radially outwardly from the riser wall, and a transition region between the riser wall and the frustum wall. The chemical processing vessel may further include a primary refractory layer disposed on and in direct contact with the inner surface of the exterior vessel wall. The chemical processing vessel may further include a shroud including a first end and a second end opposite the first end, the shroud disposed radially inward of the exterior vessel wall and positioned over at least a portion of the primary refractory layer. The first end of the shroud may be disposed above the transition region and the second end of the shroud may be disposed below the transition region. The shroud may include metal material.

### CROSS-REFERENCE TO RELATED APPLICATIONS

This application claims the benefit of U.S. Provisional Application Ser. No. 63/420,189 filed Oct. 28, 2022, the entire disclosure of which is hereby incorporated herein by reference.

### TECHNICAL FIELD

The present specification generally relates to chemical processing vessels and methods of operating the same.

### BACKGROUND

In general, some methods of operating a chemical processing vessel include contacting a chemical reactant with a fluidized catalyst in the chemical processing vessel. The chemical reactant and the fluidized catalyst then react to form a chemical product. This reaction may generate heat within the chemical processing vessel. Accordingly, an inner surface of the chemical processing vessel may be heated by the reaction between the chemical reactant and the fluidized catalyst while an outer surface of the chemical processing vessel may be cooled by ambient surroundings. This may generate a thermal gradient through the chemical processing vessel which may result in cracking and other forms of fatigue or failure of the chemical processing vessel.

### SUMMARY

Chemical processes that convert feed chemicals into products may utilize fluidized particulates, such as catalysts. Some of these processes utilize chemical processing vessels, such as reactors, that include refractory and have a generally narrowing geometry in the direction of fluidized particulate flow, where a riser wall is positioned above a frustum wall, and where a transition region is between the riser wall and the frustum wall, sometimes adjoining these wall sections. Described herein are chemical processing vessels with such a shape that include a shroud. Such a shroud may be positioned over at least a portion of a refractory layer in the chemical process vessel at or near the transition region. In some embodiments, such a shroud may be suitable for protecting refractory materials from damage caused by exposure to fluidized particulates. In particular, it has been found that in similar vessels that do not include a shroud, such vessels may have damage to the refractory, particularly where the walls of the chemical processing vessel have a lower temperature than the fluidized particulate. In such embodiments, it is believed that the relatively hot fluidized particulate may encroach into the refractory, causing thermal stress and potential cracking of the refractory. Moreover, it is believed that this damage is more severe at or near the transition region, since there may be pressure increase near this area, sometimes called a “choke point.” Embodiments described herein may mitigate such issues.

According to one or more embodiments, a chemical processing vessel may be operated by a method comprising contacting a chemical reactant with a fluidized particulate in the chemical processing vessel to form a chemical product, wherein the fluidized particulate and the chemical reactant moves in a generally upward direction through the chemical processing vessel. The chemical processing vessel may comprise an exterior vessel wall forming a continuous passage extending therethrough, wherein the exterior vessel wall has a wall temperature of less than 350° C. during operation. The exterior vessel wall may comprise a riser wall having a substantially continuous cross-sectional shape, a frustum wall positioned below the riser wall and having a variable cross-sectional shape extending radially outwardly from the riser wall, and a transition region between the riser wall and the frustum wall. The chemical processing vessel may further comprise a primary refractory layer disposed on and in direct contact with the inner surface of the exterior vessel wall. The chemical processing vessel may further comprise a shroud comprising a first end and a second end opposite the first end, the shroud disposed radially inward of the exterior vessel wall and positioned over at least a portion of the primary refractory layer. The first end of the shroud may be disposed above the transition region and the second end of the shroud may be disposed below the transition region. The shroud may comprise metal material.

According to one or more additional embodiments, a chemical processing vessel may comprise an exterior vessel wall forming a continuous passage extending therethrough, wherein the exterior vessel wall has a wall temperature of less than 350° C. The exterior vessel wall may comprise a riser wall having a substantially continuous cross-sectional shape, a frustum wall positioned below the riser wall and having a variable cross-sectional shape extending radially outwardly from the riser wall, and a transition region between the riser wall and the frustum wall. The chemical processing vessel may further comprise a primary refractory layer disposed on and in direct contact with the inner surface of the exterior vessel wall. The chemical processing vessel may further comprise a shroud comprising a first end and a second end opposite the first end, the shroud disposed radially inward of the exterior vessel wall and positioned over at least a portion of the primary refractory layer. The first end of the shroud may be disposed above the transition region and the second end of the shroud may be disposed below the transition region. The shroud may comprise metal material and may have a temperature of from 500° C. to 900° C.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a chemical reactor, according to one or more embodiments disclosed herein;

FIG. 2 schematically depicts a cross-sectional view of a portion of the chemical reactor of FIG. 1, according to one or more embodiments disclosed herein; and

FIG. 3 schematically depicts a chemical processing system, according to one or more embodiments disclosed herein.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### DETAILED DESCRIPTION

Reference will now be made in detail to various embodiments of devices, assemblies, and methods, examples of which are illustrated in the accompanying drawings. Whenever possible, the same reference numerals will be used throughout the drawings to refer to the same or like parts.

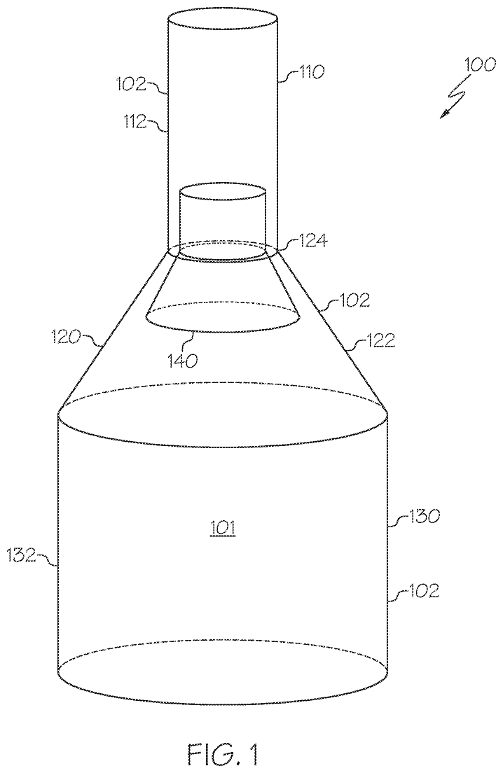

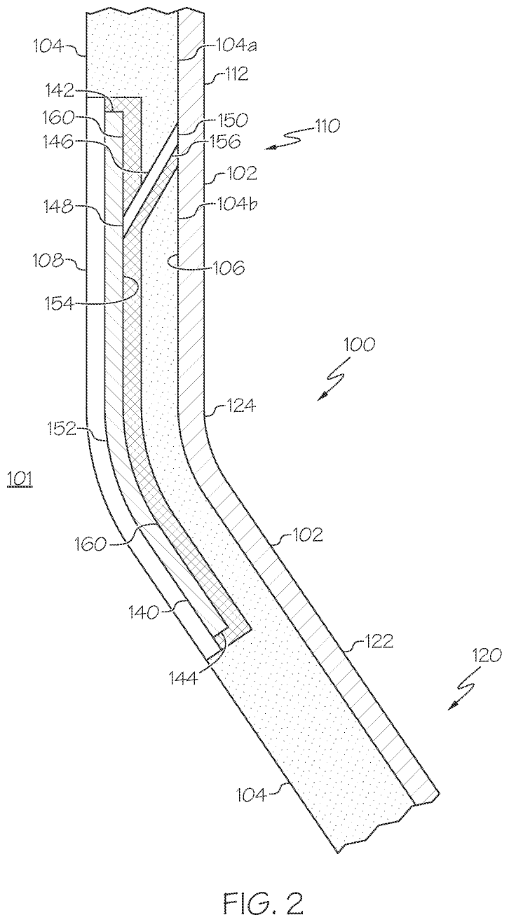

The present disclosure generally relates to chemical processing vessel and the operation of such. Referring to FIG. 1, a perspective view of a chemical processing vessel 100 is schematically depicted. The chemical processing vessel 100 may include a reaction vessel 130 and a riser 110 disposed above the reaction vessel 130. As depicted, the chemical processing vessel 100 may include an exterior vessel wall 102 extending from the riser 110 to the reaction vessel 130, defining the exterior shape and size of the riser 110 and the reaction vessel 130, respectively. The exterior vessel wall 102 may form a continuous passage 101 extending therethrough. Between the reaction vessel 130 and the riser 110 may be a transition section 120, which may be substantially frustum-shaped. The transition section 120 may join the reaction vessel 130 with the riser 110, transitioning in diameter between the size of the riser 110 may be a transition section 120. The exterior vessel wall 102 may include a riser wall 112 positioned about the riser 110, a frustum wall 122 positioned about the transition section 120, and a vessel wall 132 positioned about the reaction vessel 130. The riser wall 112 and the frustum wall 122 may join at a transition region 124 of the exterior vessel wall 102. The transition region 124 may be in its cross-sectional shape to accommodate the attachment of the riser wall 112 to the frustum wall 122, or may include a non-curved attachment point in terms of shape in its cross section. For example, FIG. 2 depicts a curved transition region 124 between the riser wall 112 to the frustum wall 122, which are each non-curved in the cross-sectional direction, as shown.

As depicted in FIG. 1, the chemical processing vessel 100 may additionally include a shroud 140. The shroud 140 is generally positioned within the exterior vessel wall 102 and is positioned at or near the transition region 124. The shroud 140 is described in greater detail herein, particularly with respect to FIG. 2.

As depicted, the riser wall 112 may have a substantially continuous cross-sectional shape. In particular, the riser wall 112 may have a substantially circular cross-sectional shape, such as depicted. However, other shapes are contemplated and possible. For example, the riser wall 112 may be any round, polygonal, regular or irregular shape. In embodiments, the riser wall 112 may have a characteristic diameter that is greater than 50 inches, greater than 75 inches, or greater than 100 inches. The riser wall 112 may have a wall thickness that is greater than 1 inch, greater than 3 inches, or greater than 5 inches. The riser wall 112 may be made from a metal, metal alloy, or any other suitable material.

Now referring to FIGS. 1 and 2, the frustum wall 122 may have a substantially frustum shape. In particular, the frustum wall 122 may have a variable cross-sectional shape such that the frustum wall 122 extends radially outwardly from the riser wall 112. In other words, the frustum wall 122 may have a narrow characteristic diameter near the riser wall 112 and may have a wider characteristic diameter further downward from the riser wall 112. In some embodiments, the frustum wall 122 may be integral with the riser wall 112. In other embodiments, the frustum wall 122 may be coupled to the riser wall 112 via weld or other coupling method. The frustum wall 122 may be made from the same material as the riser wall 112 or a different material. The frustum wall 122 may have a wall thickness that is greater than 1 inch, greater than 3 inches, or greater than 5 inches. The frustum wall 122 may be made from a metal, metal alloy, or any other suitable material.

Now referring to FIG. 2, the chemical processing vessel 100 may include a primary refractory layer 104 disposed on and in direct contact the exterior vessel wall 102. In particular, the primary refractory layer 104 may be disposed on and in direct contact with an inner surface 106 of the exterior vessel wall 102. The primary refractory layer 104 may be disposed on both the riser wall 112 and the frustum wall 122 of the exterior vessel wall 102. As depicted, in some embodiments, the primary refractory layer 104 may be thicker than the exterior vessel wall 102. In particular, the primary refractory layer 104 may be greater than 2 inches, greater than 4 inches, or greater than 6 inches. The primary refractory layer may be made from concrete or other refractory material.

Referring now to FIGS. 1 and 2 in combination, the chemical processing vessel 100 may include a shroud 140. The shroud 140 may extend between a first end 142 and a second end 144. The shroud 140 may be disposed radially inward of the exterior vessel wall 102 and positioned over at least a portion of the primary refractory layer 104, such as depicted. The first end 142 of the shroud 140 may be disposed above the transition region 124 of the exterior vessel wall 102 and the second end 144 of the shroud 140 may be disposed below the transition region 124. Accordingly, the shroud 140 may span across the transition region 124. The shroud 140 may be a metal, metal alloy, or other suitable material. In particular, the shroud 140 may be made from stainless steel or Inconel.

It has been observed that in convention embodiments void of a shroud 140, during operation, fluidized particulate may penetrate the primary refractory layer 104. For example, particulate may move into pores in the refractory. Such penetration may be particularly present at or near the transition region 124, since at this area the changing cross-sectional diameter of fluid flow may create a “choke point.” Such a fluidization phenomena may promote penetration of the particulates into the refractory particularly if vertical cracks exist or are formed, which is generally undesirable. For example, permanent damage and even large scale cracking of the refractory may be a result. Embodiments described herein may mitigate such issues by providing the shroud 140 as described herein.

The shroud 140 may include an attachment member 146 that retains the shroud 140 in place relative to the exterior vessel wall 102. As depicted, the attachment member 146 may have or comprise a substantially frustum shape. Accordingly, the attachment member 146 may have a narrow end 148 and a wide end 150. As depicted, the wide end 150 may be positioned above the narrow end 148. The attachment member 146 may extend between the shroud 140 and the exterior vessel wall 102 such that the narrow end 148 is coupled to the shroud 140 and the wide end 150 is coupled to the exterior vessel wall 102. As depicted, the attachment member 146 may separate a top portion 104a of the primary refractory layer 104 from a bottom portion 104b of the primary refractory layer 104. Accordingly, the attachment member 146 may prevent fluid communication between the top portion 104a of the primary refractory layer 104 and the bottom portion 104b of the primary refractory layer 104.

As depicted, the attachment member 146 may be coupled to the shroud 140 between the first end 142 and the second end 144 of the shroud 140. However, in other embodiments, the attachment member 146 may be coupled to the first end 142 or to the second end 144 of the shroud 140. As depicted, the attachment member 146 may be coupled to the exterior vessel wall 102 at the riser wall 112. However, as will be described in greater detail herein, other locations are contemplated and possible. In embodiments, the attachment member 146 may be formed integrally with the shroud 140 or the exterior vessel wall 102 or both. In other embodiments, the attachment member 146 may be coupled to the shroud 140 or the exterior vessel wall 102 or both via weld or other coupling method.

In one or more embodiments, the shape of attachment member 146, as described herein, may be advantageous to allow for thermal growth of the shroud 140. For example, and without limitation, the shroud 140 may be exposed to relatively high temperature conditions, causing expansion and contraction through cycled processes or shutdowns. The shape of the attachment member 146 may allow for radial expansion of the shroud 140 without undue stress on the connection points between the attachment member 146 and the shroud 140 and exterior vessel wall 102, respectively. Still referring to FIG. 1, the attachment member 146 may be oriented relative to the shroud 140 and exterior vessel wall 102 such that it may flex upon expansion of the shroud 140. Such expansion of the shroud 140 (due to high temperatures) along with relative non-expansion of the exterior vessel wall 102 reduces the space between the shroud 140 and the exterior vessel wall 102 when the shroud 140 is heated (e.g., during chemical reaction processing as described herein). The attachment member 146 may flex to allow for such movement of the shroud 140. The attachment member 146 may, in embodiments described herein, have a thickness that allows for flexure but also allowing for adequate strength to support the shroud 140. For example, the thickness of the attachment member 146 may be sufficiently thin as to be somewhat flexible but thick enough to support the weight of the shroud 140.

In embodiments, the angle between the attachment member 146 and each of the shroud 140 and the exterior vessel wall 102 may be from 10 degrees to 50 degrees, such as from 20 degrees to 40 degrees. This angle is measured between the attachment member 146 along its straightest direction (in the area between the shroud 140 and the exterior vessel wall 102) with respect to the direction of the shroud 140 and the exterior vessel wall 102 (usually each vertical). Such angles may allow for radial flexure between hot and cold states of the shroud 140.

Still referring to FIGS. 1 and 2, the chemical processing vessel 100 may include a secondary refractory layer 108. The secondary refractory layer 108 may be coupled to the shroud 140 at a radially inner surface 152 of the shroud 140. The secondary refractory layer may be made from concrete or other refractory material. In some embodiments, the secondary refractory layer 108 may be the same refractory material as the primary refractory layer 104. In other embodiments, the secondary refractory layer 108 may be a different refectory material than the primary refractory later 108. In some embodiments, the secondary refractory layer is an erosion resistant refractory in hex mesh like Rescocast AA22S, ATCHEM 85, of R-Max MP.

Still referring to FIGS. 1 and 2, the chemical processing vessel 100 may include a compressible refractory layer 160. The compressible refractory layer 160 may be coupled to the shroud 140 at a radially outer surface 154 of the shroud 140. Accordingly, in embodiments, the shroud 140 may be spaced apart from the primary refractory layer 104 by the compressible refractory layer 160. In some embodiments, the compressible refractory layer 160 may alternatively or additionally be coupled to the attachment member 146 at a radially outer surface 156 of the attachment member 146. As depicted, for example, in FIG. 2, the compressible refractory layer 160 is coupled to both the radially outer surface 154 of the shroud 140 and the radially outer surface of the attachment member 146. The compressible refractory layer 160 may be made from ceramic wool, concrete or other refractory material. The compressible refractory layer 160 may be made from a more compressible material than the primary refractory layer 104. In some embodiments, the compressible refractory layer 160 may be the same refractory material as the secondary refractory layer 108. In other embodiments, the compressible refractory layer 160 may be a different refectory material than the primary refractory later 108. In some embodiments, the primary refractory layer is a light weight (65-90 lb/ft³ fired density) or medium weight refractory (90-140 lb/ft³ fired density).

Still referring to FIGS. 1 and 2, in one or more embodiments, the chemical processing vessel 100 may be operated as part of a fluidized bed process, where a fluidized particulate and a chemical reactant may be contacted within the chemical processing vessel 100 to form a chemical product. In some embodiments, the fluidized particulate may be a fluidized catalyst. The fluidized particulate and the chemical reactant may move in a generally upwards direction through the chemical processing vessel 100. As used in the present disclosure the term “generally upward direction” means that the average velocity of the chemical reactant and the fluidized particulate is in the upward direction, where the upward direction is against the pull of gravity. As it is an average, the velocity of the gas molecules and particles within the chemical processing vessel 100 may have a distribution and may not be equal to the average, but taken as a whole the velocity of the chemical reactant and the fluidized particulate will average out to be generally upward.

In one or more embodiments, the chemical reactant may have a residence time within the chemical processing vessel 100 of less than 10 seconds, such less than 9 seconds, less than 8 seconds, less than 7 seconds, less than 6 seconds, less than 5 seconds, less than 4 seconds, or even less than 3 seconds.

In one or more embodiments, the chemical processing vessel 100 may operate at a temperature of greater than or equal to 550° C. and less than or equal to 800° C. In some embodiments, the temperature in the chemical processing vessel 100 may be from 625° C. or 650° C. to 770° C. In other embodiments, the temperature in the chemical processing vessel 100 may be from 700° C. to 750° C.

In some embodiments, the chemical processing vessel 100 may operate at a pressure of at least atmospheric pressure (about 14.7 psia). In some embodiments, the chemical processing vessel 100 may operate at a pressure of about 500 psia. In other embodiments, the chemical processing vessel 100 may operate at a pressure from about 4 psia to about 160 psia, from about 20 psia to about 100 psia, or from about 30 psia to about 80 psia.

The residence time of the fluidized particulate in the chemical processing vessel 100 may typically vary from 0.5 seconds (sec) to 240 sec. In other embodiments, the residence time of the fluidized particulate may be from about 0.5 sec to about 200 sec, from about 0.5 sec to about 100 sec, from about 0.5 sec to about 50 sec, or about 0.5 sec to about 20 sec.

In additional embodiments, the ratio of the fluidized particulate to the chemical reactants in the chemical processing vessel 100 may range from 5 to 150 on a weight to weight (w/w) basis. In some embodiments, the ratio may range from 10 to 40, such as from 12 to 36, or from 12 to 24.

In additional embodiments, the flux of the fluidized particulate may be from 1 pound per square foot-second (lb/ft²-s) (about 4.89 kg/m²-s) to 300 lb/ft²-s (to about 97.7 kg/m²-s), such as from 1-20 lb/ft²-s, in the reaction vessel 130, and from 1 lb/ft²-s (about 48.9 kg/m²-s) to 300 lb/ft²-s (about 489 kg/m²-s), such as from 10-100 lb/ft²-s, in the riser 110.

In one or more embodiments, the fluidized particulate may be capable of fluidization. In some embodiments, the fluidized particulate may exhibit properties known in the industry as “Geldart A” or “Geldart B” properties. Particles may be classified as “Group A” or “Group B” according to D. Geldart, Gas Fluidization Technology, John Wiley & Sons (New York, 1986), 34-37; and D. Geldart, “Types of Gas Fluidization,” Powder Technol. 7 (1973) 285-292, which are incorporated herein by reference in their entireties.

Group A is understood by those skilled in the art as representing an aeratable powder, having a bubble-free range of fluidization; a high bed expansion; a slow and linear deaeration rate; bubble properties that may include a predominance of splitting/recoalescing bubbles, with a maximum bubble size and large wake; high levels of solids mixing and gas backmixing, assuming equal U−Umf (U is the velocity of the carrier gas, and Umf is the minimum fluidization velocity, typically though not necessarily measured in meters per second, m/s, i.e., there is excess gas velocity); axisymmetric slug properties; and no spouting, except in very shallow beds. The properties listed tend to improve as the mean particle size decreases, assuming equal cfp; or as the <45 micrometers (μm) proportion is increased; or as pressure, temperature, viscosity, and density of the gas increase. In general, the particles may exhibit a small mean particle size and/or low particle density (<1.4 grams per cubic centimeter, g/cm³), fluidize easily, with smooth fluidization at low gas velocities, and may exhibit controlled bubbling with small bubbles at higher gas velocities.

Group B is understood by those skilled in the art as representing a “sand-like” powder that starts bubbling at Umf; that exhibits moderate bed expansion; a fast deaeration; no limits on bubble size; moderate levels of solids mixing and gas backmixing, assuming equal U−Umf; both axisymmetric and asymmetric slugs; and spouting in only shallow beds. These properties tend to improve as mean particle size decreases, but particle size distribution and, with some uncertainty, pressure, temperature, viscosity, or density of gas seem to do little to improve them. In general, most of the particles having a particle size (cfp) of 40 μm<cfp<500 μm when the density (pp) is 1.4<pp<4 g/cm³, and preferably 60 μm<cfp<500 μm when the density (pp) is 4 g/cm³ and 250 μm<cfp<100 μm when the density (pp) is 1 g/cm³.

In one or more embodiments, the fluidized particulate in the chemical processing vessel 100 may have a temperature of from 500° C. to 900° C. (sometimes referred to as the “particulate temperature”). For example, the fluidized particulate in the chemical processing vessel 100 may have a temperature of from 500° C. to 800° C., from 500° C. to 700° C., from 500° C. to 600° C., from 600° C. to 900° C., from 600° C. to 800° C., from 600° C. to 700° C., from 700° C. to 900° C., from 700° C. to 800° C., or from 800° C. to 900° C. These are temperatures that may generally be needed for efficient conversion of desired chemical, and can vary based on the reaction mechanism and feeds utilized. The shroud 140 may generally be exposed to these temperatures and have a temperature in these ranges.

Referring still to FIGS. 1 and 2, in one or more embodiments, the exterior vessel wall 102 may have a temperature at least 300° C. less than the temperature of the fluidized particulate in the chemical processing vessel 100. For example, the exterior vessel wall 102 may have a temperature at least 350° C. less than the temperature of the fluidized particulate, at least 400° C. less, at least 450° C. less, at least 500° C. less, at least 550° C. less, at least 600° C. less, at least 650° C. less, or even at least 700° C. less. In some embodiments, the exterior vessel wall 102 may have a temperature of less than 350° C. during operation of the chemical processing vessel 100, such as less than 300° C., less than 250° C., less than 200° C., less than 150° C., less than 100° C., or even less than 50° C. Such embodiments may be referred to sometimes a “cold wall” reactors, where the vessel wall is substantially cooler than the contents inside the vessel. The shroud 140 may generally be exposed to the particulate temperatures and have a temperature difference in these ranges. For example, the exterior vessel wall 102 may have a temperature at least 350° C. less than the temperature of the shroud 140.

In such embodiments where the particulate is hotter than the exterior vessel wall 102, damage to the refractory by penetration of particulate material may be especially severe, or at least worse than in embodiments where the particulate and exterior vessel wall 102 have a more uniform temperature profile. Without being bound by theory, relatively hot particulate that penetrates at or near the exterior vessel wall 102 may cause damage by thermal stress by undesired expansion of materials such as the primary refractory layer 104, the exterior vessel wall 102, and other components therearound. Cracking of various refractory layers may result.

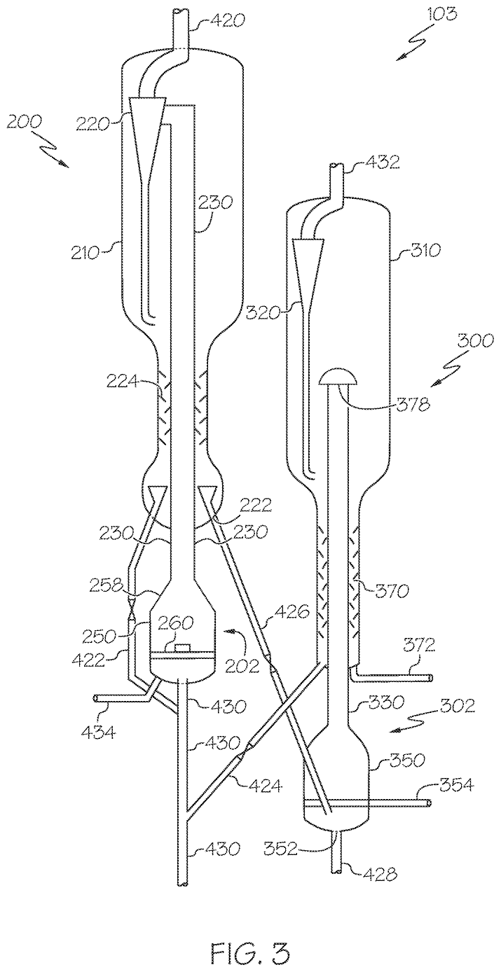

Embodiments of chemical processing vessels, such as those described in the context of FIGS. 1 and 2 may be suitable for a wide variety of chemical conversion system and associated processes. One or more non-limiting examples of such suitable systems are depicted in FIG. 3 and described in detail herein.

The chemical processing system of FIG. 3 operating as a fluidized reactor system to produce olefinic compounds from hydrocarbon feed streams. However, it should be understood that the principles disclosed and taught herein may be applicable to other systems which utilize different system components oriented in different ways, or different reaction schemes utilizing various catalyst compositions and chemical reactants. For example, the concepts described may be equally applied to other systems with alternate reactor units and regeneration units, such as those that operate under non-fluidized conditions or include downers rather than risers. It should be further understood that not all portions of the reactor system of FIG. 3 should be construed as essential to the claimed subject matter. The reactor portion 200 comprises a reactor 202, which may include an upstream reactor section 250 and a downstream reactor section 230. Reactor 202 of FIG. 3 corresponds to chemical processing vessel 100 of FIGS. 1 and 2. In embodiments, reactor 202 may include shroud 140, though not shown in FIG. 3.

Now referring to FIG. 3, an example reactor system 103 that may be suitable for use with the methods and/or apparatuses described herein is schematically depicted. The reactor system 103 generally comprises multiple system components, such as a reactor portion 200 and a regeneration unit 300. As described herein, “system components” refer to portions of the reactor system 103, such as reactors, separators, transfer lines, combinations thereof, and the like. As used herein in the context of FIG. 1, the reactor portion 200 generally refers to the portion of a reactor system 103 in which the major process reaction takes place (e.g., dehydrogenation) to form the product stream. A feed stream enters the reactor portion 200, is converted to a product stream (containing product and unreacted feed), and exits the reactor portion 200. According to one or more embodiments, as depicted in FIG. 3, the reactor portion 200 may additionally include a solid separation section 210, which serves to separate the fluidized particulate from the chemical products formed in the reactor 202. The fluidized particulate may pass through a strip zone 224 before being passed to the regeneration unit 300. Also, as used herein, the regeneration unit 300 generally refers to the portion of the reactor system 103 where the fluidized particulate is in some way processed, such as by combustion, to, e.g., improve catalytic activity and/or heat the fluidized particulate. The regeneration unit 300 may comprise a combustor 350 and a riser 330, and may additionally comprise a solid separation section 310. In one or more embodiments, the solid separation section 210 may be in fluid communication with the combustor 350 (e.g., via standpipe 426) and the solid separation section 310 may be in fluid communication with the upstream reactor section 250 (e.g., via standpipe 424 and transport riser 430).

Generally, as is described herein, in embodiments illustrated in FIG. 3, the fluidized particulate is cycled between the reactor portion 200 and the regeneration unit 300. It should be understood that when fluidized particulates are referred to herein, they may refer to solid materials that are catalytically active for a desired reaction, or may equally refer to other fluidized particulates referenced with respect to the system of FIG. 3 which do not necessarily have catalytic activity but affect the reaction, such as oxygen-carrier materials. The terms “catalytic activity” and “catalyst activity” refer to the degree to which the fluidized particulate is able to catalyze the reactions conducted in the reactor system 103. The fluidized particulate that exits the reactor portion 200 may be deactivated fluidized particulate. As used herein, “deactivated” may refer to a fluidized particulate which has reduced catalytic activity or is cooler as compared to fluidized particulate entering the reactor portion 200. However, deactivated fluidized particulate may maintain some catalytic activity. Reduced catalytic activity may result from contamination with a substance such as coke. Reactivation (sometimes called “regeneration” herein) may remove the contaminant such as coke, raise the temperature of the fluidized particulate, or both. In embodiments, deactivated fluidized particulate may be reactivated by fluidized particulate reactivation in the regeneration unit 300. The deactivated fluidized particulate may be reactivated by, but not limited to, removing coke by combustion, recovering catalyst acidity, oxidizing the fluidized particulate, other reactivation process, or combinations thereof. In some embodiments, the fluidized particulate may be heated during reactivation by combustion of a fuel, such as hydrogen, methane, ethane, propane, natural gas, or combinations thereof. The reactivated fluidized particulate from the regeneration unit 300 may then be passed back to the reactor portion 200.

The feed stream may enter feed inlet 434 into the reactor 202, and the product stream may exit the reactor system 103 via pipe 420. According to one or more embodiments, the reactor system 103 may be operated by feeding a chemical feed (e.g., in a feed stream) and the fluidized particulate into the upstream reactor section 250. The chemical feed contacts the fluidized particulate in the upstream reactor section 250, and each flow upwardly into and through the downstream reactor section 230 to produce a chemical product.

Now referring to FIG. 3 in detail, the reactor portion 200 may comprise an upstream reactor section 250, a transition section 258, and a downstream reactor section 230, such as a riser. The transition section 258 may connect the upstream reactor section 250 with the downstream reactor section 230. As depicted in FIG. 3, the upstream reactor section 250 may be positioned below the downstream reactor section 230. Such a configuration may be referred to as an upflow configuration in the reactor 202. The upstream reactor section 250 may include a vessel, drum, barrel, vat, or other container suitable for a given chemical reaction. As depicted in FIG. 3, the upstream reactor section 250 may be connected to the downstream reactor section 230 via the transition section 258. The upstream reactor section 250 may generally comprise a greater cross-sectional area than the downstream reactor section 230. The transition section 258 may be tapered from the size of the cross-section of the upstream reactor section 250 to the size of the cross-section of the downstream reactor section 230 such that the transition section 258 projects inwardly from the upstream reactor section 250 to the downstream reactor section 230. For example, the transition section 258 may be a frustum.

The upstream reactor section 250 may be connected to a transport riser 430, which, in operation may provide reactivated fluidized particulate in a feed stream to the reactor portion 200. The reactivated catalyst and/or reactant chemicals may be mixed with a distributor 260 housed in the upstream reactor section 250. The fluidized particulate entering the upstream reactor section 250 via transport riser 430 may be passed through standpipe 424 to a transport riser 430, thus arriving from the regeneration unit 300. In some embodiments, fluidized particulate may come directly from the solid separation section 210 via standpipe 422 and into a transport riser 430, where it enters the upstream reactor section 250, where in such embodiments some of the fluidized particulate is not passed through the regeneration unit 300. The fluidized particulate can also be fed via standpipe 422 directly to the upstream reactor section 250 (not depicted in FIG. 3). This fluidized particulate may be somewhat deactivated, but may still, in some embodiments, be suitable for reaction in the upstream reactor section 250, particularly when used in combination with reactivated fluidized particulate.

Still referring to FIG. 3, in one or more embodiments, based on the shape, size, and other processing conditions (such as temperature and pressure) in the upstream reactor section 250 and the downstream reactor section 230, the upstream reactor section 250 may operate as a fluidized bed, such as in a fast fluidized, turbulent, or bubbling bed upflow reactor, while the downstream reactor section 230 may operate in more of a plug flow manner, such as in a riser reactor. For example, the reactor 202 of FIG. 1 may comprise an upstream reactor section 250 operating as a fast fluidized, turbulent, or bubbling bed reactor and a downstream reactor section 230 operating as a dilute phase riser reactor, with the result that the average fluidized particulate and gas flow moves concurrently upward. As the term is used herein, “average flow” refers to the net flow, i.e., the total upward flow minus the retrograde or reverse flow, as is typical of the behavior of fluidized particles in general. As described herein, a “fast fluidized” reactor may refer to a reactor utilizing a fluidization regime wherein the superficial velocity of the gas phase is greater than the choking velocity and may be semi-dense in operation. As described herein, a “turbulent” reactor may refer to a fluidization regime where the superficial velocity of less than the choking velocity and is more dense than the fast fluidized regime. As described herein, a “bubbling bed” reactor may refer to a fluidization regime wherein well defined bubbles in a highly dense bed are present in two distinct phases. The “choking velocity” refers to the minimum velocity required to maintain solids in the dilute-phase mode in a vertical conveying line. As described herein, a “dilute phase riser” may refer to a riser reactor operating at transport velocity, where the gas and fluidized particulate have about the same velocity in a dilute phase.

According to embodiments, the chemical product and the fluidized particulate may be passed out of the downstream reactor section 230 to a separation device 220 in the solid separation section 210, where the fluidized particulate is separated from the chemical product, which is transported out of the solid separation section 210. According to one or more embodiments, following separation from vapors in the separation device 220, the fluidized particulate may generally move through the strip zone 224 to the solid outlet port 222 where the fluidized particulate is transferred out of the reactor portion 200 via standpipe 426 and into the regeneration unit 300.

According to one or more embodiments, the separation device 220 may be a cyclonic separation system, which may include two or more stages of cyclonic separation. In embodiments where the separation device 220 comprises more than one cyclonic separation stages, the first separation device into which the fluidized stream enters is referred to a primary cyclonic separation device. The fluidized effluent from the primary cyclonic separation device may enter into a secondary cyclonic separation device for further separation. Primary cyclonic separation devices may include, for example, primary cyclones, and systems commercially available under the names VSS (commercially available from UOP), LD2 (commercially available from Stone and Webster), and RS2 (commercially available from Stone and Webster). Primary cyclones are described, for example, in U.S. Pat. Nos. 4,579,716; 5,190,650; and 5,275,641, which are each incorporated by reference in their entirety herein. In some separation systems utilizing primary cyclones as the primary cyclonic separation device, one or more set of additional cyclones, e.g. secondary cyclones and tertiary cyclones, are employed for further separation of the fluidized particulate from the product gas. It should be understood that any primary cyclonic separation device may be used in embodiments of the invention.

Still referring to FIG. 1, the separated fluidized particulate is passed from the solid separation section 210 to the combustor 350. In the combustor 350, the fluidized particulate may be processed by, for example, combustion with oxygen. For example, and without limitation, the fluidized particulate may be de-coked and/or fuel may be combusted to heat the fluidized particulate. The fluidized particulate is then passed out of the combustor 350 and through the riser 330 to a riser termination separator 378, where the gas and solid components from the riser 330 are at least partially separated. The vapor and remaining solids are transported to a secondary separation device 320 in the solid separation section 310 where the remaining fluidized particulate is separated from the gases from the fluidized particulate processing (e.g., gases emitted by combustion of spent fluidized particulate or fuel, referred to herein as flue gas). The flue gas may pass out of the regeneration unit 300 via outlet pipe 432. The separated fluidized particulate is then passed through the oxygen treatment zone 370 within the solid separation section 310 to the upstream reactor section 250 via standpipe 424 and transport riser 430, where it is further utilized in a catalytic reaction. Thus, the fluidized particulate, in operation, may cycle between the reactor portion 200 and the regeneration unit 300. In general, the processed chemical streams, including the feed streams and product streams may be gaseous, and the fluidized particulate may be a fluidized solid.

Referring now to the regeneration unit 300, as depicted in FIG. 3, the combustor 350 of the regeneration unit 300 may include one or more lower reactor portion inlet ports 352 and may be in fluid communication with the riser 330. Oxygen-containing gas, such as air, may be passed through pipe 428 into the combustor 350. The combustor 350 may be in fluid communication with the solid separation section 210 via standpipe 426, which may supply spent fluidized particulate from the reactor portion 200 to the regeneration unit 300 for regeneration. The combustor 350 and riser 330, collectively referred to as the combustion reactor 302, may operate with similar or identical fluidization regimes as to what was disclosed with respect to the upstream reactor section 250 and downstream reactor section 230 of the reactor portion 200. That is, the combustor 350 may operate as a fluidized bed, such as in a fast fluidized, turbulent, or bubbling bed upflow reactor, while the riser 330 may operate in more of a plug flow manner, such as in a riser reactor. Geometries as described with respect to the upstream reactor section 250 and downstream reactor section 230 may equally apply to the combustor 350 and riser 330. Additionally, the combustor 350 may also include a fuel inlet 354, which may supply a fuel, such as a hydrocarbon stream or hydrogen, to the combustor 350.

In one or more embodiments, the embodiments of FIGS. 1 and 2 may be suitable for use in the regeneration unit. Specifically, the processing vessels of FIGS. 1 and 2 could be utilized as combustor 350 in the embodiment of FIG. 3.

As described in one or more embodiments, following separation of flue gas from fluidized particulate in the riser termination separator 378 and secondary separation device 320, treatment of the processed fluidized particulate with an oxygen-containing gas is conducted in the oxygen treatment zone 370. In some embodiments, the oxygen treatment zone 370 includes a fluid solids contacting device. The fluid solids contacting device may include baffles or grid structures to facilitate contact of the processed fluidized particulate with the oxygen-containing gas. Examples of fluid solid contacting devices are described in further detail in U.S. Pat. Nos. 9,827,543 and 9,815,040. The fluidization regime within the oxygen treatment zone 370 may be bubbling bed type fluidization. The oxygen treatment zone 370 may include an oxygen-containing gas inlet 372, which may supply an oxygen-containing gas to the oxygen treatment zone 370 for oxygen treatment of the fluidized particulate.

In non-limiting examples, the reactor system 103 described herein may be utilized to produce olefinic compounds from hydrocarbon feed streams. As used herein, the term “olefinic compounds” refers to hydrocarbons having one or more carbon-carbon double bonds apart from the formal double bonds in aromatic compounds. For example, ethylene and styrene are olefinic compounds, but ethylbenzene would not be an olefinic compound as the only double bonds present in ethylbenzene are formal double bonds present as part of the aromatic structure. Olefinic compounds may be produced from a variety of hydrocarbon feed streams by utilizing different reaction mechanisms. For example, olefinic compounds may be produced by at least dehydrogenation reactions, cracking reactions, dehydration reactions, and methanol-to-olefin reactions. These reaction types may utilize different feed streams and different fluidized particulates to produce olefinic compounds. It should be understood that when “catalysts” are referred to herein, they may equally refer to the fluidized particulate referenced with respect to the system of FIG. 3.

According to one or more embodiments, the reaction may be a dehydrogenation reaction. According to such embodiments, the one or more hydrocarbons may be a hydrocarbon feed stream the hydrocarbon feed stream may comprise one or more of ethylbenzene, ethane, propane, n-butane, and i-butane. In one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethylbenzene. In one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of propane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of n-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of i-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of the sum of ethylbenzene, ethane, propane, n-butane, and i-butane.

In one or more embodiments, the dehydrogenation reaction may utilize gallium and/or platinum fluidized particulates as a catalyst. In such embodiments, the fluidized particulates may comprise a gallium and/or platinum catalyst. As described herein, a gallium and/or platinum catalyst comprises gallium, platinum, or both. The gallium and/or platinum catalyst may be carried by an alumina or alumina silica support, and may optionally comprise potassium. Such gallium and/or platinum catalysts are disclosed in U.S. Pat. No. 8,669,406, which is incorporated herein by reference in its entirety. However, it should be understood that other suitable catalysts may be utilized to perform the dehydrogenation reaction.

In one or more embodiments, the reaction mechanism may be dehydrogenation followed by combustion (in the same chamber). In such embodiments, a dehydrogenation reaction may produce hydrogen as a byproduct, and an oxygen carrier material may contact the hydrogen and promote combustion of the hydrogen, forming water. Examples of such reaction mechanisms, which are contemplated as possible reactions mechanisms for the systems and methods described herein, are disclosed in WO 2020/046978 and U.S. Pat. Pub. No. 2021/0292259 the teachings of which are incorporated by reference in their entireties herein.

In one or more embodiments, the fluidized particulate may comprise an oxygen-carrier material and a dehydrogenation catalyst material. In some embodiments, the fluidized particulate may consist essentially of the oxygen-carrier material. As described herein, “consists essentially of” refers to materials with less than 1 wt. % of the non-recited materials (i.e., consisting essentially of A means A is at least 99 wt. % of the composition). In some embodiments, the fluidized particulate may not comprise a dehydrogenation catalyst material. In some embodiments, the oxygen-carrier material and the dehydrogenation catalyst material may be separate particles of the fluidized particulate. In some embodiments, the oxygen-carrier material and the dehydrogenation catalyst may be contained in the same particles of the fluidized particulate.

In embodiments where the fluidized particulate comprises a dehydrogenation catalyst, the dehydrogenation of the one or more hydrocarbons may be at least partially by catalytic dehydrogenation. Catalytic dehydrogenation is the dehydrogenation of a hydrocarbon that is promoted by the use of a dehydrogenation catalyst. In embodiments, where the fluidized particulate does not comprise a dehydrogenation catalyst the dehydrogenation reaction may be a non-catalytic thermal dehydrogenation reaction. Non-catalytic thermal dehydrogenation refers to the dehydrogenation of a hydrocarbon that occurs without the use of a dehydrogenation catalyst and instead may occur because of high temperature, pressure or combinations thereof.

In some embodiments, the fluidized particulate may comprise a “dual-purpose material” that may act as both a dehydrogenation catalyst as well as an oxygen-carrier material. It should be understood that, in at least the embodiments described herein where an oxygen-carrier material and a dehydrogenation catalyst are utilized in the same reaction vessel (such as those of FIG. 1), such a dual-purpose material may be utilized either in replacement or in combination with the oxygen-carrier material of the fluidized particulate or the dehydrogenation catalyst of the fluidized particulate.

According to one or more embodiments, the reaction may be a cracking reaction. According to such embodiments, the hydrocarbon feed stream may comprise one or more of naphtha, n-butane, or i-butane. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of naphtha. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of n-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of i-butane. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of the sum of naphtha, n-butane, and i-butane.

In one or more embodiments, the cracking reaction may utilize one or more zeolites as a catalyst. In such embodiments, the fluidized particulates may comprise one or more zeolites. In some embodiments, the one or more zeolites utilized in the cracking reaction may comprise a ZSM-5 zeolite. However, it should be understood that other suitable catalysts may be utilized to perform the cracking reaction. For example, suitable catalysts that are commercially available may include Intercat Super Z Excel or Intercat Super Z Exceed. In additional embodiments, the cracking catalyst may comprise, in addition to a catalytically active material, platinum. For example, the cracking catalyst may include from 0.001 wt. % to 0.05 wt. % of platinum. The platinum may be sprayed on as platinum nitrate and calcined at an elevated temperature, such as around 700° C. Without being bound by theory, it is believed that the addition of platinum to the catalyst may allow for easier combustion of fuels, such as methane.

According to one or more embodiments, the reaction may be a dehydration reaction. According to such embodiments, the hydrocarbon feed stream may comprise one or more of ethanol, propanol, or butanol. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of ethanol. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of propanol. In additional embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of butanol. In additional embodiments, the hydrocarbon feed stream or may comprise at least 50 wt. %, at least 60 wt. %, at least 70 wt. %, at least 80 wt. %, at least 90 wt. %, at least 95 wt. % or even at least 99 wt. % of the sum of ethanol, propanol, and butanol.

In one or more embodiments, the dehydration reaction may utilize one or more acid catalysts. In such embodiments, the fluidized particulates may comprise one or more acid catalysts. In some embodiments, the one or more acid catalysts utilized in the dehydration reaction may comprise a zeolite (such as ZSM-5 zeolite), alumina, amorphous aluminosilicate, acid clay, or combinations thereof. For example, commercially available alumina catalysts which may be suitable, according to one or more embodiments, include SynDol (available from Scientific Design Company), V200 (available from UOP), or P200 (available from Sasol). Commercially available zeolite catalysts which may be suitable include CBV 8014, CBV 28014 (each available from Zeolyst). Commercially available amorphous aluminosilicate catalysts which may be suitable include silica-alumina catalyst support, grade 135 (available from Sigma Aldrich). However, it should be understood that other suitable catalysts may be utilized to perform the dehydration reaction.

According to one or more embodiments, the reaction may be a methanol-to-olefin reaction. According to such embodiments, the hydrocarbon feed stream may comprise methanol. According to one or more embodiments, the hydrocarbon feed stream may comprise at least 50 wt. %, at least 60 wt. %, at least 70 wt. %, at least 80 wt. %, at least 90 wt. %, at least 95 wt. % or even at least 99 wt. % of methanol.

In one or more embodiments, the methanol-to-olefin reaction may utilize one or more zeolites as a catalyst. In such embodiments, the fluidized particulates may comprise one or more zeolites. In some embodiments, the one or more zeolites utilized in the methanol-to-olefin reaction may comprise a one or more of a ZSM-5 zeolite or a SAPO-34 zeolite. However, it should be understood that other suitable catalysts may be utilized to perform the methanol-to-olefin reaction.

In one or more embodiments, the olefinic compounds may be present in a “product stream” sometimes called an “olefin-containing effluent”. Such a stream exits the reactor system of FIG. 1 and may be subsequently processed. In one or more embodiments, the olefinic compounds may comprise one or more of ethylene, propylene, butylene, or styrene. The term butylene includes any isomers of butylene, such as α-butylene, cis-β-butylene, trans-β-butylene, and isobutylene. In some embodiments, the olefin-containing effluent may comprise at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or even at least 75 wt. % of ethylene. In additional embodiments, the olefin-containing effluent may comprise at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or even at least 75 wt. % of propylene. In additional embodiments, the olefin-containing effluent may comprise at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or even at least 75 wt. % of butylene. In additional embodiments, the olefin-containing effluent may comprise at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or even at least 75 wt. % of styrene. In additional embodiments, the olefin-containing effluent may comprise at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, or even at least 75 wt. % of the sum of one or more of ethylene, propylene, butylene, and styrene. The olefin-containing effluent may further comprise unreacted components of the feed stream, as well as other reaction products that are not considered light olefins. The olefinic compounds may be separated from unreacted components in subsequent separation steps.

The present disclosure includes numerous aspects. One aspect is a method of operating a chemical processing vessel, the method comprising: contacting a chemical reactant with a fluidized particulate in the chemical processing vessel to form a chemical product, wherein the fluidized particulate and the chemical reactant moves in a generally upward direction through the chemical processing vessel, and wherein the chemical processing vessel comprises: an exterior vessel wall forming a continuous passage extending therethrough, wherein the exterior vessel wall has a wall temperature of less than 350° C. during operation, and wherein the exterior vessel wall comprises: a riser wall having a substantially continuous cross-sectional shape; a frustum wall positioned below the riser wall and having a variable cross-sectional shape extending radially outwardly from the riser wall; and a transition region between the riser wall and the frustum wall; a primary refractory layer disposed on and in direct contact with the inner surface of the exterior vessel wall; and a shroud comprising a first end and a second end opposite the first end, the shroud disposed radially inward of the exterior vessel wall and positioned over at least a portion of the primary refractory layer, wherein the first end of the shroud is disposed above the transition region and the second end of the shroud is disposed below the transition region, and wherein the shroud comprises metal material.

Another aspect is any single above aspect or combination of above aspects, wherein the chemical processing vessel further comprises an attachment member having a frustum shape extending between the shroud and the exterior vessel wall, wherein the attachment member comprises a narrow end and a wide end.

Another aspect is any single above aspect or combination of above aspects, wherein the wide end of the attachment member is coupled to the riser wall.

Another aspect is any single above aspect or combination of above aspects, wherein the wide end of the attachment member is coupled to the frustum wall.

Another aspect is any single above aspect or combination of above aspects, wherein the attachment member separates a top portion of the primary refractory layer from a bottom portion of the primary refractory layer and wherein the attachment member prevents fluid communication between the top portion of the primary refractory layer and the bottom portion of the primary refractory layer.

Another aspect is any single above aspect or combination of above aspects, wherein wide end of the attachment member is position above the narrow end.

Another aspect is any single above aspect or combination of above aspects, wherein the wide end of the attachment member is positioned below the narrow end.

Another aspect is any single above aspect or combination of above aspects, wherein the at least a portion of the primary refractory layer is maintained at a higher pressure than the continuous passage.

Another aspect is any single above aspect or combination of above aspects, wherein the shroud is spaced apart from the primary refractory layer.

Another aspect is any single above aspect or combination of above aspects, further comprising a compressible refractory layer disposed between the shroud and the primary refractory layer.

Another aspect is any single above aspect or combination of above aspects, wherein the shroud is substantially contoured to the exterior vessel wall.

Another aspect is any single above aspect or combination of above aspects, further comprising a secondary refractory layer disposed radially inward of the shroud.

Another aspect is any single above aspect or combination of above aspects, wherein the fluidized particulate has a particulate temperature, wherein the wall temperature is lower than the particulate temperature.

Another aspect is any single above aspect or combination of above aspects, wherein the temperature of the exterior vessel wall is at least 300° C. less than the temperature of the fluidized particulate, and wherein the temperature of the fluidized particulate is between 500° C. and 900° C.

Another aspect is a chemical processing vessel comprising: an exterior vessel wall forming a continuous passage extending therethrough, wherein the exterior vessel wall has a wall temperature of less than 350° C., and wherein the exterior vessel wall comprises: a riser wall having a substantially continuous cross-sectional shape; a frustum wall positioned below the riser wall and having a variable cross-sectional shape extending radially outwardly from the riser wall; and a transition region between the riser wall and the frustum wall; a primary refractory layer disposed on and in direct contact with the inner surface of the exterior vessel wall; and a shroud comprising a first end and a second end opposite the first end, the shroud disposed radially inward of the exterior vessel wall and positioned over at least a portion of the primary refractory layer, wherein the first end of the shroud is disposed above the transition region and the second end of the shroud is disposed below the transition region, wherein the shroud comprises metal material and has a temperature of from 500° C. to 900° C.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

As would be understood in the context of the term as used herein, the term “passing” may include directly passing a substance between two portions of the disclosed system and, in some other instances, to mean indirectly passing a substance between two portions of the disclosed system. For example, indirect passing may include steps where the named substance passes through an intermediate separation device, valve, sensor, etc.

1. A method of operating a chemical processing vessel, the method comprising:
contacting a chemical reactant with a fluidized particulate in the chemical processing vessel to form a chemical product, wherein the fluidized particulate and the chemical reactant moves in a generally upward direction through the chemical processing vessel, and wherein the chemical processing vessel comprises:
an exterior vessel wall forming a continuous passage extending therethrough, wherein the exterior vessel wall has a wall temperature of less than 350° C. during operation, and wherein the exterior vessel wall comprises:
a riser wall having a substantially continuous cross-sectional shape;
a frustum wall positioned below the riser wall and having a variable cross-sectional shape extending radially outwardly from the riser wall; and
a transition region between the riser wall and the frustum wall;
a primary refractory layer disposed on and in direct contact with the inner surface of the exterior vessel wall; and
a shroud comprising a first end and a second end opposite the first end, the shroud disposed radially inward of the exterior vessel wall and positioned over at least a portion of the primary refractory layer, wherein the first end of the shroud is disposed above the transition region and the second end of the shroud is disposed below the transition region, and wherein the shroud comprises metal material.

2. The method of claim 1, wherein the chemical processing vessel further comprises an attachment member having a frustum shape extending between the shroud and the exterior vessel wall, wherein the attachment member comprises a narrow end and a wide end.

3. The method of claim 2, wherein the wide end of the attachment member is coupled to the riser wall.

4. The method of claim 2, wherein the wide end of the attachment member is coupled to the frustum wall.

5. The method of claim 2, wherein the attachment member separates a top portion of the primary refractory layer from a bottom portion of the primary refractory layer and wherein the attachment member prevents fluid communication between the top portion of the primary refractory layer and the bottom portion of the primary refractory layer.

6. The method of claim 2, wherein wide end of the attachment member is position above the narrow end.

7. The method of claim 2, wherein the wide end of the attachment member is positioned below the narrow end.

8. The method of claim 1, wherein the at least a portion of the primary refractory layer is maintained at a higher pressure than the continuous passage.

9. The method of claim 1, wherein the shroud is spaced apart from the primary refractory layer.

10. The method of claim 1, further comprising a compressible refractory layer disposed between the shroud and the primary refractory layer.

11. The method of claim 1, wherein the shroud is substantially contoured to the exterior vessel wall.

12. The method of claim 1, further comprising a secondary refractory layer disposed radially inward of the shroud.

13. The method of claim 1, wherein the fluidized particulate has a particulate temperature, wherein the wall temperature is lower than the particulate temperature.

14. The method of claim 13, wherein the temperature of the exterior vessel wall is at least 300° C. less than the temperature of the fluidized particulate, and wherein the temperature of the fluidized particulate is between 500° C. and 900° C.

15. A chemical processing vessel comprising:
an exterior vessel wall forming a continuous passage extending therethrough, wherein the exterior vessel wall has a wall temperature of less than 350° C., and wherein the exterior vessel wall comprises:
a riser wall having a substantially continuous cross-sectional shape;
a frustum wall positioned below the riser wall and having a variable cross-sectional shape extending radially outwardly from the riser wall; and
a transition region between the riser wall and the frustum wall;
a primary refractory layer disposed on and in direct contact with the inner surface of the exterior vessel wall; and
a shroud comprising a first end and a second end opposite the first end, the shroud disposed radially inward of the exterior vessel wall and positioned over at least a portion of the primary refractory layer, wherein the first end of the shroud is disposed above the transition region and the second end of the shroud is disposed below the transition region, wherein the shroud comprises metal material and has a temperature of from 500° C. to 900° C.
